(19) United States
(12) Patent Application Publication
(10) Pub. No.: US 2003/0224137 A1
(43) Pub. Date: Dec. 4, 2003

(54) Fastener and method of manufacturing the same

(76) Inventor: Han Bong Chung, Seoul (KR)

Correspondence Address: JACOBSON HOLMAN PLLC, 400 SEVENTH STREET N.W., SUITE 600, WASHINGTON, DC, 20004, US

(21) Appl. No.: 10/157,809

(22) Filed: May 31, 2002

(51) Int. Cl. B32B 3/10

(52) U.S. Cl. 428/85; 428/131

(57) ABSTRACT

The present invention relates to a fastener tape for use in clothing, bags, footwear, binders, and the like, which is composed of mutually attachable components, and to a method of manufacturing the same. According to the present invention, there is provided a fastener tape formed by applying an adhesive onto the back sides of at least one of sheet materials on which hook or loop components are formed, and by bonding the sheet materials with each other. Further, the present invention relates to a fastener tape by which products can be wound or attached in all directions, and which a bag opening can be bound, any objects can be wound, or a plurality of objects can be fastened in a bundle by cutting the fasten tape into various shapes, particularly in the form of bands. Furthermore, the present invention relates to a method of manufacturing a thin fastener tape and having various flexibility, wherein sheet materials are joined with various adhesives interposed through a suitable process for the adhesive so that differing flexibility can be provided according to its use.

### BACKGROUND OF THE INVENTION

1. Field of the Invention

The present invention relates to a fastener tape for use in clothing, bags, footwear, binders, and the like, which is composed of mutually attachable components, and to a method of manufacturing the same. More particularly, the present invention relates to a fastener tape with proper flexibility for respective uses by applying an adhesive onto the back side of at least one of sheet materials so that hook and loop components may be formed on both sides of the fastener tape, respectively, and by compressing and heating the sheet materials with the adhesive applied thereon by means of a device for manufacturing a fastener tape according to the present invention so as to bond the sheet materials with each other.

2. Description of the Prior Art

In general, a fastener tape, which is called a “magic tape” or “Velcro,” is well known in the art. The fastener tape is manufactured by forming hook and loop components on sheet materials, respectively, which are woven to have a constant width, positioning the sheet materials to face each other and then joining the sheet materials together with predetermined pressure. Alternatively, the fastener tape may be manufactured by forming both of hook and loop components on the sheet materials, positioning the sheet materials to face each other and then joining the sheet materials together with predetermined pressure. The fastener tape manufactured as such is used to fasten an object to a certain position or attach any objects to each other. Since the sheet materials composed of the fastener tape are usually made of fiber, the fastener tape is widely used as adhesion or opening means for various kinds of clothing, footwear, bags, and the like.

In a conventional fastener tape, hook and loop components are formed on two different sheet materials to be attached to each other, respectively. When the sheet materials are to be attached to each other, one sheet material with the hook components formed thereon and the other sheet material with the loop components formed thereon are attached to face each other so that the hook components can be caught in the loop components. Here, the hook components are formed on the sheet material in the various forms including a clip type obtained by cutting a portion of the loop component, a mushroom type formed by melting a top portion of the hook component, in order to obtain large attachment force by coupling them with the loop components. The loop components are formed on the sheet material in the various forms including a constantly spaced ring type, a spring type, an irregularly arranged ring type, and the like. Further, the hook and loop components may be formed integrally with the sheet material, or be woven together with the sheet material. Furthermore, a fabric is attached to the back side of the sheet material with the hook components or the loop components formed thereon. For example, if the sheet materials are to be attached to an object such as clothing, footwear, bags, or the like, one sheet material with one of either the hook or loop components formed thereon and with the fabric attached to the back side thereof is easily sewn or bonded with an adhesive at a desired position of the object, and then comes into close contact with and is attached to an additional sheet material having the other of hook or loop components. The sheet material is bonded to the fabric in such a manner that an acrylic-based or rubber-based adhesive is applied between the back side of the sheet material and the fabric, and is cured at a room temperature spontaneously or after compression thereof. According to such a bonding method, a thick adhesive layer is formed between the sheet material and the fabric and is not flexible due to curing thereof. Thus, its application is limited. Furthermore, since any bubbles remaining in the adhesive layer cannot be effectively removed, uniform adhesion force is not formed throughout the adhesive layer. Thus, there has been a problem in that the sheet material and the fabric are separated at a weak adhesive portion when the fastener tape is frequently attached and/or detached.

In general, the hook and loop components formed on the sheet material are made of a synthetic fiber which is composed of a thermoplastic polymer such as nylon, polyester, or polypropylene.

As described above, a fastener tape of which respective materials with different components are attached to each other to fix an object is widely used. However, there have not yet been disclosed any techniques whereby hook and loop components are formed on both sides of the sheet materials, respectively, in order to wrap and attach objects to each other with a fastener tape having the shape of the present invention. Although it is slightly different from the present invention in view of their objects, there is disclosed a fastener in which hook and loop components are formed on both sides of the fastener, respectively, to fasten a curved object or where an end of a looped sheet material is bonded to a hooked sheet material so that the fastener can be used as a tie.

U.S. Pat. No. 6,205,623 discloses composite hook and loop fasteners, and products containing them. According to the '623 patent, each of the composite hook and loop fasteners in the form of an elongated strip is manufactured in the form of a wrap tie such that loop components are formed on one face of the elongated strip and an end of another strip with hook components formed thereon is affixed to an end of the back side of the loop strip in a state where an adhesive is interposed between the hook strip and a release liner. The adhesive may be pressure sensitive adhesive or a synthetic resin. In the case where the synthetic resin is used as the adhesive, the end of the loop strip is attached to the hook strip by applying heat to the synthetic resin. The fastener manufactured as such is used to bind bags by tightening and wrapping around a bag opening with the fastener, and then securing the loop strip to the hook strip. There is a problem in that since an area where the hook components and the loop components are engaged with each other is determined depending on the hook components or the loop components formed on the release liner, it is difficult to tightly bind the bag opening in a case where a bag has a large volume or the content contained within the bag is a material which tends to be easily deformed. Furthermore, since the wrap tie is completed by attaching the release liner and the other strip with different components to the end of the elongated strip, a number of manufacturing processes are needed. Thus, more time and costs are required.

U.S. Pat. No. 4,931,344 discloses a fastener component. According to the '344 patent, the fastener component is provided with hook-like interlocking elements on the front side of a substrate sheet and an anchor member on the back side. The fastener component is also provided with at least one flat portion void of the interlocking elements on the front side of the substrate sheet to make the fastener component flexible or pliable so that it can be easily fitted into a curved or bent portion of a mold. Since the anchor member is bonded to a curved or bent portion of a molded body anchored on the mold, the mold is engaged together with the molded body by the fastener component. In addition, in order to more easily bond the substrate sheet with the fastener component formed thereon to the mold and molded body, magnetic metal strips are formed in a lateral direction on the front sides of both longitudinal ends of the fastener component. In order to protect the interlocking elements inserted into a groove formed in an inner side of the mold, a protective film is formed and vertically folded at both widthwise edges of the substrate sheet. The fastener component is not used as a band. However, since the hook-like interlocking elements and anchor members are formed therein, the fastener component is used to attach matching objects taking the shape of the same corresponding surfaces, such as the mold and the molded body, to each other. Since the substrate sheets on which the interlocking elements and the anchor members are formed are bonded to each other by means of a synthetic resin and then cured, a fastener tape is manufactured in a stiff state. Thus, since the fastener tape has a property that it cannot be easily bent when it is bonded to a surface of a curved object, it is not suitable for application to a sharply curved surface. In order to solve this problem, a number of flat portions are formed widthwise on the front side of the fastener component. However, the flat portions basically fail to provide flexibility with the fastener tape and various manufacturing processes should be carried out so as to form the magnetic metal strip and the number of flat portions on both sides of the fastener tape. Thus, there are problems in that the structure of the manufacturing device becomes complex and more time and costs are required.

### SUMMARY OF THE INVENTION

The present invention is contemplated to solve the above problems in the prior art. An object of the present invention is to provide a fastener tape on which hook and loop components are formed on both sides thereof, respectively, by applying an adhesive onto the back side of tape-shaped sheet materials with hook or loop components formed thereon and then joining the sheet materials together. Another object of the present invention is to provide a fastener tape by which products can be wound or attached in all directions, a bag opening can be bound, any objects can be wound, or numerous objects can be fastened in a bundle by cutting the fasten tape into various shapes, particularly in the form of bands. A further object of the present invention is to provide a method of manufacturing a thin fastener tape and having varied flexibility, wherein sheet materials are joined with various adhesives interposed through a suitable process for the adhesive so that differing flexibility can be provided according to its use.

According to the present invention for accomplishing the above object objective, there is provided a fastener tape formed by causing the back sides of upper and lower sheet materials with hook components and/or loop components formed thereon to mutually face each other and integrally bonding the sheet materials to each other with an adhesive, the adhesive being polyester-based urethane resin comprising 60 to 70% of urethane resin, 20 to 30% of toluene, 10 to 20% of butyl acetate and 5 to 10% of methyl ethyl ketone.

There is also provided a fastener tape formed by causing the back sides of upper and lower sheet materials with hook components and/or loop components formed thereon to mutually face each other and integrally bonding the sheet materials to each other with an adhesive, the adhesive being polyamide-based caprolactam resin comprising 40 to 50% of resor phenol resin, 20 to 30% of water (H2O), 15 to 20% of methanol, 10 to 15% of polyamide resin and 1 to 3% of sodium hydroxide (NaOH).

The fastener tape is cut in a band type to have a head portion, a body portion and a tail portion; the head portion has a width larger than that of the body portion and a hole having a predetermined size for allowing the tail portion to pass therethrough and be attached to the body portion; the body portion has a width for allowing the body portion to smoothly pass through the hole of the head portion and extends longitudinally with constant width; and the tail portion is formed to have a width equal to or smaller than the largest diameter of the hole formed in the head portion.

An end of the tail portion is rounded to allow it to easily pass through the hole of the head portion.

An end of the tail portion is formed to have a width small enough to easily pass through the hole of the head portion and to be recessed on both sides thereof.

An end of the tail portion is tapered to easily pass through the hole of the head portion.

Furthermore, according to the present invention for accomplishing the above object, there is provided a method of manufacturing a fastener tape formed by causing the back sides of upper and lower sheet materials with hook components and/or loop components formed thereon to mutually face each other and integrally bonding the sheet materials to each other with an adhesive, comprising of the steps of: supplying the upper and lower sheet materials by guide rollers; applying the adhesive by using an application means for applying the adhesive onto a back side of either of the upper sheet material or the lower sheet material; joining one sheet material with the adhesive applied to the back side thereof and the other sheet material orientated in a direction opposite to that of the one sheet material together by passing the sheet materials through a pressure roller to cause the sheet materials to come into close contact with each other; and winding the fastener tape joined by the pressure roller about a winder for manufacturing it as a product.

The method further comprises the step of curing and aging an adhesive layer of the fastener tape wound about the winder in an aging room at room temperature for a predetermined period of time after the winding step.

The method further comprises, between the joining and winding steps, the steps of compressing the joined fastener tape by turning an advance direction of the fastener tape by means of a compression roller so that any bubbles remaining in an adhesive layer can be removed; and thermally bonding the fastener tape that has passed through the compression roller by passing the fastener tape through a plurality of heating rollers in a state where the fastener tape comes into close contact with the heating rollers.

The application means is a surface nozzle positioned above the back side of either the upper sheet material or the lower sheet material for discharging the adhesive to be applied onto the back side, and the adhesive applying step is performed by using the surface nozzle.

The application means is a resin roller positioned below and in contact with the back side of either the upper sheet material or the lower sheet material for coating the adhesive contained within a resin pan onto the back side, and the adhesive applying step is performed in such a manner that the resin in contact with the back side of the sheet material applies the adhesive onto the backside while the sheet materials are fed.

In order to allow the adhesive to be uniformly applied onto the back side of the sheet material in the adhesive applying step, a coating knife is horizontally attached to one side of the resin pan and spaced apart from the resin roller with a predetermined gap so that a constant amount of the adhesive can be applied.

### BRIEF DESCRIPTION OF THE DRAWINGS

The above and other objects and features of the present invention will become apparent from the following description of preferred embodiments given in conjunction with the accompanying drawings, in which:

FIG. 1 is a sectional view of a fastener tape according to an embodiment of the present invention;

FIG. 2 is a sectional view of a fastener tape according to another embodiment of the present invention;

FIG. 3 is a schematic view of a fastener tape manufacturing device for compression bonding sheet materials for the fastener tape according to the present invention;

FIG. 4 is a schematic view of the fastener tape manufacturing device for thermally bonding the sheet materials for the fastener tape according to the present invention;

FIG. 5 is a perspective view of the fastener tape wound by the fastener tape manufacturing device according to the present invention;

FIG. 6 is a view showing a usage state of the fastener tape according to the present invention; and

FIGS. 7a to 7e are plan views of various configurations of the fastener tape 1a, 1b formed in a band type according to the present invention.

### DETAILED DESCRIPTION OF THE PREFERRED EMBODIMENTS

Hereinafter, preferred embodiments of the present invention will be described in detail with reference to the accompanying drawings.

In order to facilitate easy explanation of the preferred embodiments of the present invention, assume that a sheet material with hook components 11, 12 formed thereon is an upper sheet material 13 and a sheet material with loop components 21 formed thereon is a lower sheet material 22, as shown in the drawings.

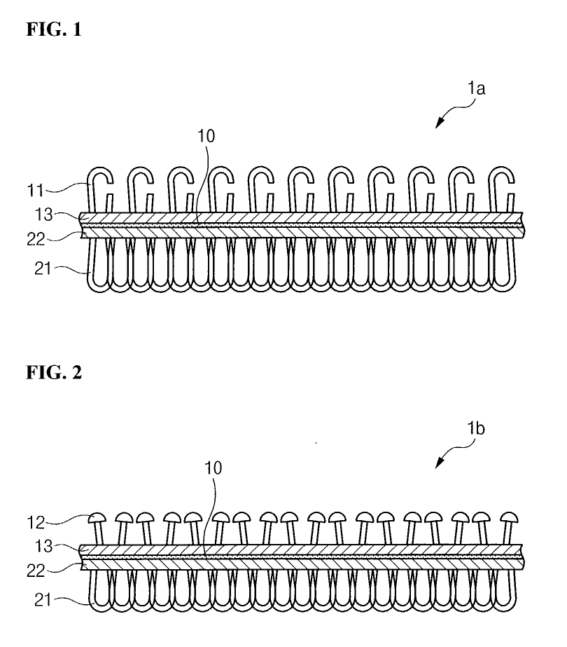

FIG. 1 is a sectional view of a fastener tape 1a according to an embodiment of the present invention.

The fastener tape 1a is constructed such that the upper and lower sheet materials 13, 22 are integrally bonded to each other in a state where an adhesive layer 10 is interposed between the back sides of the upper sheet material 13 with a plurality of hook components 11 formed thereon and the lower sheet materials 22 with a plurality of loop components 21 formed thereon. The hook components 11 take the shape of a ring which is most generally used, and are formed by cutting a portion of a loop taking the shape of a monofilament. The hook and loop components 11, 21 formed on opposite sides of the fastener tape 1a are not limited to be made of specific materials. Considering flexibility and elasticity, the hook components 11 is generally made of nylon, but may be made of polyester, if desired. Similarly, the loop components 21 are preferably made of nylon.

An adhesive forming the adhesive layer 10 of the fastener tape 1a, 1b may be variously selected and used depending on the use of application. In the present inventions, the adhesive is classified into two categories: the first one is for use in a fastener tape 1a, 1b with relatively high strength and the second one is for use in a fastener tape with a relatively low strength based on the degree of flexibility of the fastener tape 1a, 1b. Now, the adhesives for use in two kinds of the fastener tapes will be described. A value of flexibility of the fastener tape which is most widely used is preferably equal to or less than 1.3 lbs/25 mm. In order to help the understanding of the value of flexibility, a reference value of flexibility is described below. That is, the value of flexibility of the upper and lower sheet materials 13, 22 before the sheet materials have been attached to each other is within a range of 0.24 to 0.4 lbs/25 mm.

First, an adhesive mainly composed of a polyester-based urethane resin with a curing agent contained therein is used to manufacture a fastener tape with relatively high flexibility. The adhesive comprises 60 to 70% of urethane resin, 20 to 30% of toluene, 10 to 20% of butyl acetate, and 5 to 10% of methyl ethyl ketone. Furthermore, it is formed by dissolving the urethane resin into a solvent. The adhesive is excellent in adhesion property to metal and other materials, wear resistance, oil resistance and chemical resistance; and it has superior elasticity and excellent vibration absorption. The fastener tape, which has been manufactured by applying the adhesive onto the back sides of the sheet materials 13, 22, and then compression bonding the sheet materials, has the value of flexibility of 2 to 2.4 lbs/25 mm, and thus, the flexibility of the fastener tape is slightly lowered. Therefore, the fastener tape is used to bind less deformable objects such as bags and footwear, and other objects having large diameters. In such a case, there is an advantage in that the fastener tape can be mass-produced since the adhesive layer 10 is rapidly cured due to the curing agent contained within the adhesive.

On the other hand, an adhesive mainly composed of a polyamide-based phenol caprolactam resin with no curing agents contained therein is used to manufacture a flexible fastener tape with relatively low strength. The adhesive comprises 40 to 50% of resor phenol resin, 20 to 30% of water (H2O),15 to 20% of methanol, 10 to 15% of polyamide resin and 1 to 3% of sodium hydroxide (NaOH). The fastener tape, which has been manufactured by applying the adhesive onto the back side of one of the sheet materials 13, 22, and then compression or thermally bonding the sheet materials, has the value of flexibility of 0.9 to 1.2 lbs/25 mm, and thus, the flexibility thereof is excellent. Therefore, the adhesive is used to bind flexible objects such as clothing, and other objects having small diameters. In such a case, any bubbles remaining in the adhesive layer 10 can be completely removed and uniform curing speed can be simultaneously obtained, because the adhesive layer 10 has been cured through compression and thermal bonding of the sheet materials for a long time. Accordingly, there is an advantage in that uniform adhesive force can be obtained throughout the sheet materials 13, 22.

FIG. 2 is a sectional view of a fastener tape according to another embodiment of the present invention.

The fastener tape 1b is constructed such that the upper and lower sheet materials 13, 22 are integrally bonded to each other in a state where an adhesive layer 10 is interposed between the back sides of the upper sheet material 13 with a plurality of mushroom shaped hook components 11 formed thereon and the lower sheet materials 22 with a plurality of loop components 21 formed thereon. The mushroom shaped hook components 12 is formed by cutting top portions of loops formed on the upper sheet material 13 while coming into contact with a heated horizontal cutter, and then melting end portions of the cut loops. Here, the mushroom shaped hook components 12 are made of polypropylene.

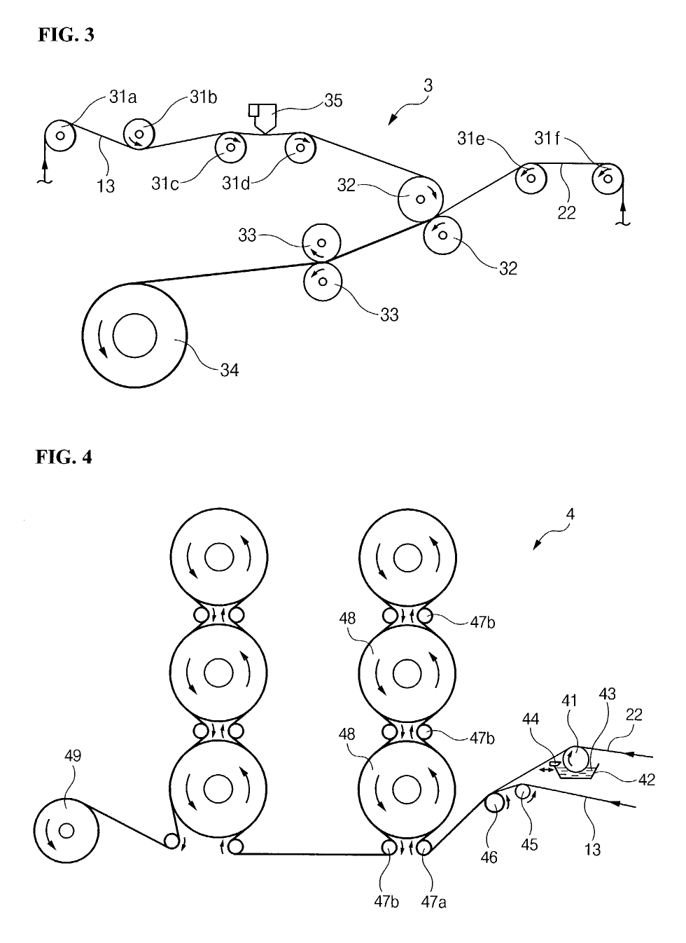

FIG. 3 is a schematic view of a fastener tape manufacturing device 3 for compression bonding the sheet materials 13, 22 for the fastener tape 1a, 1b according to the present invention. The fastener tape manufacturing device 3 comprises a plurality of guide rollers 31a to 31f for guiding into the device the sheet materials 13, 22 on which hook components 11, 12 and loop components 21 are formed thereon, respectively; a surface nozzle 35 for applying an adhesive (polyester-based urethane resin) onto the back side of one of the sheet materials 13, 22 on which the hook components 11, 12 and the loop components 21 are formed, respectively; a pressure roller 32 for bringing the sheet materials 13, 22 into close contact with each other so as to compression bond the sheet materials to each other; and a winder 34 for winding a fastener tape thereabout after completion of joining and pressurizing steps.

The sheet materials 13, 22, on which the hook components 11, 22 and the loop components 21 are respectively formed, are pulled by the rotation of the winder 34 and a drawing rollers 33, and are then introduced into the device. Thus, the supply step for the sheet materials 13, 22 is carried out. Hereinafter, in order to facilitate easy explanation of the embodiment, assume that one sheet material introduced from the left guide rollers 31a in FIG. 3 is the sheet material 13 with the hook components 11, 12 formed thereon, and the other sheet material introduced from the right guide rollers 31f in FIG. 3 is the sheet material 22 with the loop components 21 formed thereon. The sheet material 13 with the hook components 11, 12 formed thereon passes through the surface nozzle 35 serving as adhesive applying means while going through the plurality of guide rollers 31a to 31d. At this time, the adhesive is applied onto the back side of the sheet material 13. Thus, the adhesive applying step is carried out. The surface nozzle 35 for allowing the adhesive to be discharged and applied onto the sheet material 13 is positioned between the two guide rollers 31c, 31d so as to come into contact with the back side of the sheet material 13 with the hook components 11, 12 formed thereon. When applying the urethane resin onto the sheet material, the urethane resin and the solvent can be accurately discharged at a mixing ratio of 4:1 and at approximately 60° C. through a metered discharge unit. The discharge amounts of the resin can be controlled by regulating an adjusting pump (not shown) and a cross-sectional area of the surface nozzle 35. The sheet material 13 with the hook components 11, 12 formed thereon after it has passed through the surface nozzle 35 is fed to the pressure rollers 32, whereas the sheet material 22 is fed to the pressurizing rollers 32 past the plurality of guide rollers 31e, 31f. The joining step is carried out by compression bonding the back sides of the sheet material 13 with the urethane resin applied thereon and the sheet material 22 with the loop components 21 formed thereon in a state where they face each other while passing through the pressure rollers 32. At this time, the sheet materials 13, 22 are bonded to each other while they are introduced into the pressure rollers 32 by means of the drawing rollers 33.

The fastener tape 1a, 1b which has passed through the drawing rollers 33 is packaged through a winding step where it is wound about the winder 34. Subsequently to the winding step, the fastener tape 1a, 1b is completed as a final product through a curing step for curing the adhesive layer 10 for 12 hours or more in an aging room (not shown) in order to perform the aging process of the adhesive layer 10 of the fastener tape 1a, 1b wound about the winder 34. Since the fastener tape 1a, 1b is formed with the hook components 11, 12 and the loop components 21 on both sides thereof when the winding step is carried out, a problem that the hook components 11, 12 and the loop components 21 become interlocked during the winding step may occur. In order to solve this problem, the winding step may be carried out by placing a flexible separate paper sheet 51 onto the hook components 11, 12 or the loop components 21 when winding the bonded fastener tape 1a, 1b about the winder 34.

In the adhesive applying step, adjustment of the discharge amount of the urethane resin through the surface nozzle 35 is an important factor for governing the adhesion performance of the adhesive layer 10. Such a control method may be carried out by a method of adjusting the feeding speed of the fastener tape 1a, 1b other than the aforementioned method of adjusting the discharge amount of the resin from the surface nozzle 35. The sheet material 13 with the hook components 11, 12 formed thereon just before introduced into a region near the surface nozzle 35 can be kept at constant tension thereof due to phase differences between the guide rollers 31a to 31d so that the amount of the urethane resin to be applied onto the sheet material 13 through the surface nozzle 35 can be constantly maintained.

The process environment for carrying out the above steps is as follows: The feeding speed of the fastener tape 1a, 1b fed by the plurality of rollers is 8 to 12 m/min, and the fastener tape constructed by the sheet materials 13, 22 may be formed to have a width of 5 to 50 mm and cut to have predetermined lengths suitable for various usage. If desired, the fastener tape 1a, 1b may be manufactured to have a width of 50 mm or larger, and then cut to be used.

FIG. 4 is a schematic view of the fastener tape manufacturing device 4 for thermally bonding the sheet materials 13, 22 for the fastener tape 1a, 1b according to the present invention. The fastener tape manufacturing device 4 comprises a plurality of guide rollers 45 for guiding into the device the sheet materials 13, 12 on which the hook components 11, 12 and the loop components 21 are formed, respectively; a resin pan 42 and a resin roller 41 for applying an adhesive onto the backside of one of the sheet materials 13, 22 with the hook components 11, 12 or the loop components 21 formed thereon; a pressure roller 46 for abutting and joining the sheet materials 13, 22 against and to each other; a plurality of heating rollers 48 with heaters contained therewithin for thermally bonding the sheet materials for a long time by heating the adhesive layer 10 of the sheet materials 13, 22 joined through the pressure roller 46; compression rollers 47a, 47b positioned between the heating rollers 48 for further compressing the joined fastener tape 1a, 1b; and a winder 49 for winding the fastener tape 1a, 1b thereabout after completion of the joining and compressing processes.

Hereinafter, for the clarity of description of the embodiment, one sheet material introduced from above the resin roller 41 positioned at the right side in FIG. 4 is referred to a lower sheet material 22 with the loop components 21 formed thereon, and the other sheet material introduced from below the resin roller 41 is referred to an upper sheet material 13 with the hook components 11, 12 formed thereon.

The sheet materials are subjected to the sheet material supplying step in which the upper sheet material 13 with the hook components 11, 12 formed thereon reaches the pressure roller 46 via the plurality of guide rollers 45, and the lower sheet material 22 with the loop components 21 formed thereon reaches the resin roller 41 by the plurality of guide rollers 45. The lower sheet material 22 which has reached the resin roller 41 is fed while being subjected to the adhesive supplying step in which the adhesive 43 is applied onto the back side of the lower sheet material 22 with the rotation of the resin roller 41. Thus, the upper and lower sheet materials have been completely prepared for their joining to each other. The resin roller 41 is positioned in a state where a lower portion of the resin roller 41 is partially immersed in the resin pan 42 containing the adhesive (polyamide-based phenol caprolactam resin) 43, the adhesive 43 adhering to an outer periphery of the resin roller 41 comes into contact with and coated on the back side of the lower sheet material 22 while the resin roller 41 rotates in a clockwise direction. At this time, since the amount of the adhesive 43 supplied in a state of excessively adhering to the periphery of the resin roller 41 is adjusted by a coating knife 44, which is attached to one side of the resin pan 42 (the left side in FIG. 4) and spaced apart from the resin roller 41 with a predetermined gap so that a constant amount of the adhesive 43 can be applied, the constant amount of the adhesive 43 is always applied onto the back side of the lower sheet material 22. Thus, the adhesive layer 10 that is uniform and thin in thickness can be obtained. In addition, the amount of the adhesive 43 supplied by the resin roller 41 can be adjusted by horizontally shifting the coating knife 44 and adjusting the gap between the coating knife 44 and the resin roller 41.

Next, the upper and lower sheet materials 13, 22 fed by the plurality of rollers reach the pressure roller 46, and the sheet materials are subjected to the sheet material joining step in which the sheet materials are joined to each other so that they are oriented in opposite directions. Thus, a primary bonding of the sheet materials is made by the tension of the sheet materials. The fastener tape 1a, 1b that has passed through the pressure roller 46 is turned 180° while it comes into close contact with the outer periphery of the compression roller 47a positioned below the pressure roller in a diagonal direction, and is then guided to the heating roller 48 positioned above the compression roller. Thus, through such compressing step, a secondary bonding of the sheet materials is made. A large number of bubbles introduced upon joining of the sheet materials exist within the adhesive layer 10 of the primarily bonded fastener tape 1a, 1b. Thus, if the adhesive layer 10 is cured as it is, the bonding force between the upper and lower sheet materials 13, 22 at portions thereof containing the bubbles is weakened. If products are produced by cutting the fastener tape 1a, 1b, a product including such portions containing the bubbles will be judged as a defective. Therefore, in order to completely remove the bubbles existing within the adhesive layer 10 of the fastener tape 1a, 1b, the fastener tape 1a, 1b is fed while it is in close contact with and compressed by the compression rollers 47a, 47b, so that a high tension (compression force) can be applied to the middle portion of the fastener tape 1a, 1b passing around the compression rollers 47a, 47b and thus the bubbles are removed therefrom.

The fastener tape 1a, 1b that has passed through the compression rollers 47a, 47b passes through the plurality of heating rollers 48, which are arranged in series and have been heated, in a state of coming into contact with the outer peripheries of one side of the heating rollers 48. Thus, the fastener tape 1a, 1b is subjected to the thermal bonding step at a high temperature for a long time. At this time, with the compression rollers 47b installed between the heating rollers 48, the thermal bonding and compressing steps are repeatedly carried out two or more times. The heating rollers 48 are heated in a temperature range of 100 to 120° C. to provide an environment where the adhesive 43 forming the adhesive layer 10 can be cured at the same temperature condition and curing rate. Thus, flexibility is provided to the fastener tape 1a, 1b. Next, the fastener tape 1a, 1b that has passed through the heating rollers 48 is subjected to the winding step in which it is wound about the winder 49 for producing the fastener tape as products. Since a problem may occur in that since the hook components 11, 12 and the loop components 21 formed on both sides of the fastener tape 1a, 1b are attached to each other upon winding of the fastener tape, the winding step may be carried out by simultaneously placing a separate paper sheet 51 onto the outer sides of the fastener tape 1a, 1b on which the hook components 11, 12 or the loop components 21 are formed.

Finally, in order to cure the adhesive layer 10 of the fastener tape 1a, 1b, which has been wound through the winding step, at room temperature, it is subjected to the aging step for aging the adhesive layer 10 for about 12 hours in an aging room (not shown). In such a way, the fastener tape is completed as a finish product.

The process environment for carrying out the above steps is as follows: The feeding speed of the fastener tape 1a, 1b fed by the plurality of rollers is approximately 7 m/min, the stay length of the fastener tape for the entire process of carrying out the above steps is approximately 15 m, and the sheet materials 13, 22 have a width of 110 to 150 mm.

In the embodiment of the fastener tape manufacturing device 4 for thermally bonding the upper and lower sheet materials 13, 22, it has been described that the adhesive 43 is applied only onto the back side of the lower sheet material 22 with the loop components 21 formed thereon. However, the adhesive 43 may be applied onto the back side of the upper sheet material 13 with the hook components 11, 12 formed thereon to bond the upper and lower sheet materials together. Although the heating rollers 48 shown in FIG. 4 are arranged in two longitudinal columns, it is not limited thereto. The fastener tape 1a, 1b may be manufactured by carrying out the thermal bonding and compressing steps repeatedly in a state where the plurality of heating rollers 48 are arranged in a longitudinal or transverse line, or in a plurality of transverse rows.

Furthermore, the fastener tape manufacturing device 3 shown in FIG. 3 preferably uses, as the adhesive, the polyester-based urethane resin mainly composed of the urethane resin containing a curing agent in order to manufacture the fastener tape 1a, 1b having relatively high flexibility. The fastener tape manufacturing device 4 shown in FIG. 4 preferably uses, as the adhesive, the polyamide-based phenol caprolactam resin mainly composed of the resor phenol resin without a curing agent in order to manufacture the fastener tape 1a, 1b having relatively low flexibility. However, if desired, the respective fastener tape manufacturing devices 3, 4 may alternatively use one or the other of the two adhesives.

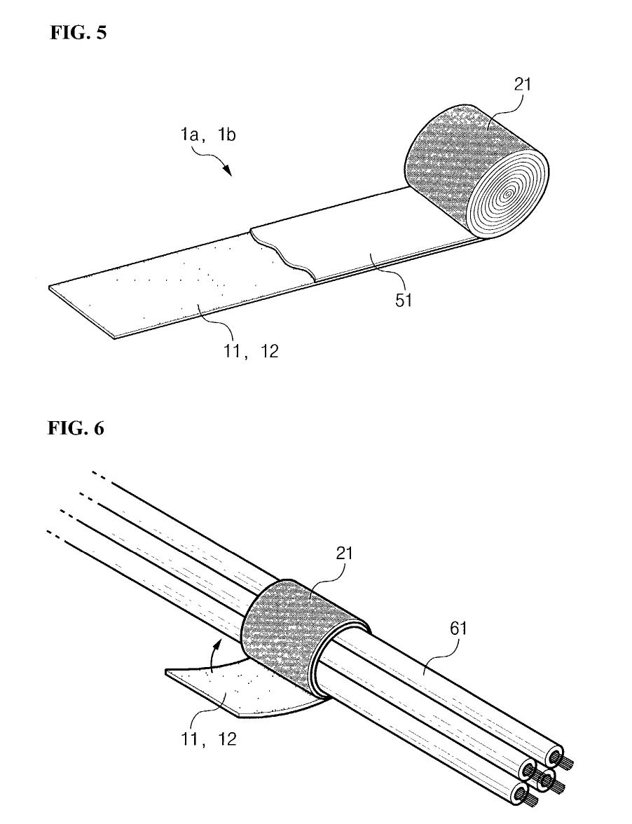

FIG. 5 is a perspective view of the fastener 1a, 1b tape wound by the fastener tape manufacturing device 3, 4 according to the present invention.

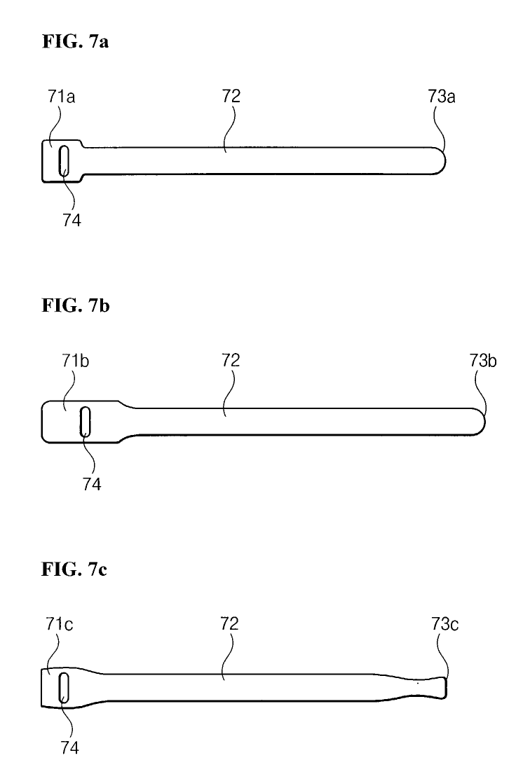

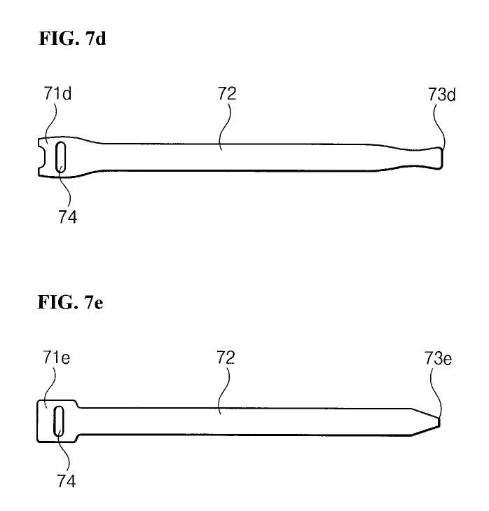

There is shown the fastener tape 1a, 1b wound in a roll type through the winding step, and the winding step has been carried out by interposing the separate paper sheet 51 between the hook components 11, 12 and the loop component 21 so that they can be prevented from being mutually coupled with each other upon winding of the fastener tape 1a, 1b. The fastener tape 1a, 1b wound in a roll type may be used as a band by appropriately cutting it depending on its application, or as a tie for arranging electrical wires 61 and the like by cutting it to have various shapes as shown in FIGS. 7a to 7e.

FIG. 6 is a view showing a usage state of the fastener tape according to the present invention.

There is shown a state where the plurality of electrical wires 61 are bound together by the fastener tape 1a, 1b, which is manufactured by means of the fastener tape manufacturing device 3, 4 shown in FIGS. 3 and 4. Since the hook components 11, 12 and the loop components 21 are generally formed on both sides of the fastener tape 1a, 1b as shown in FIGS. 1 and 2, there is an advantage in that any objects having different diameters can be bound together by wrapping the fastener tape 1a, 1b around the objects to cause the hook components 11, 12 and the loop components 21 to be mutually coupled with each other. Furthermore, since the coupling is established throughout the entire outer surface of the fastener tape 1a, 1b wrapping the objects when the binding of the objects is carried out, it is possible to maintain a firmly secured state.

The fastener tape 1a, 1b can be used as an attachment means for clothing, footwear, bags, utility devices for an automobile and the like as well as the binder for binding the objects such as the plurality of electrical wires 61. Furthermore, the fastener tape 1a, 1b may be used as a cable tie for arranging electrical wires from a switch box or electric home appliances by cutting it into the shapes as shown in FIGS. 7a to 7e. Furthermore, as an embodiment different from that of FIGS. 1 and 2, the fastener tape 1a, 1b can be manufactured by bonding the two sheet materials 13, 22 with the hook components 11, 12 and the loop components 21 formed together on one side of each sheet material.

FIGS. 7a to 7e are plan views of various configurations of the fastener tape 1a, 1b formed in a band type according to the present invention.

There are shown the band type of fastener tapes for which usage convenience is added by cutting the fastener tape 1a, 1b according to the present invention into various shapes. Each of the band type of fastener tapes comprises a head portion 71a to 71e, a body portion 72 and a tail portion 73a to 73e. The head portion 71a to 71e is formed with a hole 74 having a width larger than that of the body portion 72 for allowing the body and tail portions 72, 73a to 73e to pass through the hole, the body portion 72 has a constant width, and the tail portion 73a to 73e is rounded or formed to have a width slightly smaller than that of the body portion 72 for allowing the body portion 72 to easily enter the hole 74 formed on the head portion 71a to 71e. More particularly, the head portion 71a to 71e is formed to have a width larger than that of the body portion 72 in order to form the hole 74 in the head portion. The head portion 71a to 71e may be variously used by forming it to have various lengths suitable for easy gripping, attachment of tags or trademark labels, and the like.

An end of the tail portion 73a, 73b shown in FIGS. 7a and 7b is round-shaped to easily pass through the hole 74 of the head portion 71a, 71b, and the head portion 71b of the fastener tape shown in FIG. 7b is formed to have a length enough to be used for gripping with the hand or attachment of tags.

The end of the tail portion 73c, 73d shown in FIGS. 7c and 7d may be formed to have a small width enough to easily pass through the hole 74 of the head portion 71a, 71b, and to be recessed on both sides thereof. Alternatively, the head portion 71c, 71d may be formed by forming it in a tapered shape or partially cutting away a central portion of the end to provide a beautiful appearance.

The end of the tail portion 73e shown in FIG. 7e is tapered to easily pass through the hole 74 of the head portion 71e.

According to the present invention as described above, the sheet materials of the conventional fastener tape each of which has either the hook or loop components formed on one side thereof are bonded to each other and thus there is provided the fastener tape with the hook components and the loop components formed on both sides thereof. When the resultant fastener tape wraps or attaches an object, the coupling of the hook and loop components are established throughout the entire outer surface of the fastener tape and thus a strong attachment force is obtained. Furthermore, the adhesive layer can be formed to be thinner by applying the urethane resin or the polyamide-based phenol caprolactam resin as the adhesive onto the back side of at least one of the sheet materials and then performing compression or thermal bonding of the sheet materials. Furthermore, it is possible to obtain appropriate flexibility and excellent bonding performance owing to the characteristics of the adhesive. Since the fastener tape is simple in its structure, the manufacturing costs can be reduced and the manufacturing time can be shortened. More particularly, in a case where the polyamide-based phenol caprolactam resin is used to bond the sheet materials of the fastener tape to each other, any bubbles remaining in the adhesive layer can be completely removed by causing the sheet materials to pass through the plurality of compression and heating rollers after the sheet material joining step, and simultaneously, the thermal bonding and compressing steps are repeatedly carried out for a long time. Furthermore, excellent flexibility and uniform bonding force can be given to the entire sheet materials after the curing step by providing an environment where the adhesive constructing the adhesive layer can be cured at the same rate under a generally uniform temperature condition. Furthermore, the fastener tape can be processed in various types to be used as a cable tie for arranging electrical wires from switch boxes or electric home appliances in addition to an attachment means for clothing, footwear, bags and the like as in the prior art.

It will be apparent to the skilled in the art that the present invention is not limited to the aforementioned embodiments and accompanying drawings, and various changes and modifications can be made thereto without departing from the technical spirit of the present invention.

What is claimed is:

1. A fastener tape formed by causing the back sides of upper and lower sheet materials (13, 22) with hook components (11, 12) and/or loop components (21) formed thereon to mutually face each other and integrally bonding the sheet materials to each other with an adhesive (43), said adhesive being polyester-based urethane resin comprising 60 to 70% of urethane resin, 20 to 30% of toluene, 10 to 20% of butyl acetate and 5 to 10% of methyl ethyl ketone.

2. A fastener tape formed by causing the back sides of upper and lower sheet materials (13, 22) with hook components (11, 12) and/or loop components (21) formed thereon to mutually face each other and integrally bonding the sheet materials to each other with an adhesive (43), said adhesive being polyamide-based caprolactam resin comprising 40 to 50% of resor phenol resin, 20 to 30% of water (H2O), 15 to 20% of methanol, 10 to 15% of polyamide resin and 1 to 3% of sodium hydroxide (NaOH).

3. The fastener tape as claimed in claim 1 or 2, wherein the fastener tape 1a, 1b is cut in a band type to have a head portion (71a; 71b; 71c; 71d; 71e), a body portion (72) and a tail portion (73a; 73b; 73c; 73d; 73e); the head portion (71a; 71b; 71c; 71d; 71e) has a width larger than that of the body portion (72) and a hole (74) having a predetermined size for allowing the tail portion (73a; 73b; 73c; 73d; 73e) to pass therethrough and be attached to the body portion; the body portion (72) has a width for allowing the body portion (72) to smoothly pass through the hole (74) of the head portion (71a; 71b; 71c; 71d; 71e) and extends longitudinally with constant width; and the tail portion (73a; 73b; 73c; 73d; 73e) is formed to have a width equal to or smaller than the largest diameter of the hole (74) formed in the head portion (71a; 71b; 71c; 71d; 71e).

4. The fastener tape as claimed in claim 3, wherein an end of the tail portion (73a; 73b) is rounded to allow it to easily pass through the hole (74) of the head portion (71a; 71b).

5. The fastener tape as claimed in claim 3, wherein an end of the tail portion (73c; 73d) is formed to have a width small enough to easily pass through the hole (74) of the head portion (71c; 71d) and to be recessed on both sides thereof.

6. The fastener tape as claimed in claim 3, wherein an end of the tail portion (73e) is tapered to easily pass through the hole (74) of the head portion (71e).

7. A method of manufacturing a fastener tape (1a; 1b) formed by causing the back sides of upper and lower sheet materials (13, 22) with hook components (11, 12) and/or loop components (21) formed thereon to mutually face each other and integrally bonding the sheet materials to each other with an adhesive (43), comprising the steps of:
supplying the upper and lower sheet materials (13, 22) by guide rollers (31a to 31f; 45);
applying the adhesive by using an application means for applying the adhesive onto a back side of either of the upper sheet material (13) or the lower sheet material (22);
joining one sheet material (22) with the adhesive applied to the back side thereof and the other sheet material (13) orientated in a direction opposite to that of the one sheet material (22) together by passing the sheet materials through a pressure roller (32; 46) to cause the sheet materials to come into close contact with each other; and
winding the fastener tape (1a; 1b) joined by the pressure roller (32; 46) about a winder (34; 49) for manufacturing it as a product.

8. The method as claimed in claim 7, further comprising the step of curing and aging an adhesive layer (10) of the fastener tape (1a; 1b) wound about the winder (34; 49) in an aging room at room temperature for a predetermined period of time after the winding step.

9. The method as claimed in claim 7, further comprising, between the joining and winding steps, the steps of:
compressing the joined fastener tape (1a; 1b) by turning an advance direction of the fastener tape (1a; 1b) by means of a compression roller (47a) so that any bubbles remaining in an adhesive layer can be removed; and
thermally bonding the fastener tape (1a; 1b) that has passed through the compression roller (47a) by passing the fastener tape (1a; 1b) through a plurality of heating rollers (48) in a state where the fastener tape (1a; 1b) comes into close contact with the heating rollers.

10. The method as claimed in claim 7, wherein the application means is a surface nozzle (35) positioned above the back side of either the upper sheet material (13) or the lower sheet material (22) for discharging the adhesive to be applied onto the back side, and the adhesive applying step is performed by using the surface nozzle (35).

11. The method as claimed in claim 7, wherein the application means is a resin roller (41) positioned below and in contact with the back side of either the upper sheet material (13) or the lower sheet material (22) for coating the adhesive (43) contained within a resin pan (42) onto the back side, and the adhesive applying step is performed in such a manner that the resin (41) in contact with the back side of the sheet material applies the adhesive (43) onto the backside while the sheet materials (13, 22) are fed.

12. The method as claimed in claim 11, wherein in order to allow the adhesive (43) to be uniformly applied onto the back side of the sheet material in the adhesive applying step, a coating knife (44) is horizontally attached to one side of the resin pan (42) and spaced apart from the resin roller (41) with a predetermined gap so that a constant amount of the adhesive 43 can be applied.
